(19) United States
(12) Patent Application Publication
(10) Pub. No.: US 2014/0288967 A1
(43) Pub. Date: Sep. 25, 2014

(54) PORTABLE MEDICAL RECORD SYSTEM AND METHOD

(71) Applicant: SMARTER PADS, LLC, Cedar Park, TX (US)

(72) Inventor: Dallas Bailes, Steamboat, CO (US)

(73) Assignee: SMARTER PADS LLC, Cedar Park, TX (US)

(21) Appl. No.: 14/211,368

(22) Filed: Mar. 14, 2014

Related U.S. Application Data
(60) Provisional application No. 61/787,516, filed on Mar. 15, 2013.

(51) Int. Cl. G06F 19/00; G06F 3/0484

(52) U.S. Cl. CPC G06F 19/363; G06F 3/04842
USPC 705/3; 715/765

(57) ABSTRACT

A user is allowed to create a new button via an input device, and a processor provides an option to the user to make the button either a single- or multiple-response button. An input is accepted from the user regarding a number of responses for the button via the input device, and the processor prompts the user to input a descriptor for each of the one or more responses chosen for the button. Each such descriptor is then accepted, and the button is displayed to the user on a display. Upon the button being pressed, the press of the button is accepted, and the processor determines which of the responses was selected by the press of the button. The corresponding descriptor is then stored in an electronic memory.

### CROSS-REFERENCE TO RELATED APPLICATIONS

The present application claims priority to and incorporates herein by reference U.S. Provisional Patent Application Ser. No. 61/787,516 filed on Mar. 15, 2013.

### BACKGROUND OF THE INVENTION

When seeing a patient, a physician must typically document many aspects of the examination and/or procedure. Physicians therefore need and often use portable systems that allow, through different methods of input, the physician to record patient data and the physician's thought process regarding diagnosis and treatment. Such systems often utilize portable tablets that the physician carries around. Such a tablet may be in communication with a larger electronic medical records (EMR) system which actually stores the medical records. However, such systems are often not adaptable to different physician's practices. The conditions that patients most commonly present with in an emergency or urgent care setting may vary based on the location of the treatment facility, time or other factors. Unfortunately, many of the EMR systems presently available are not customizable in such a way to allow physicians to tailor the appearance and function of the system to fit what the physician needs.

In this regard, a physician's documentation is unique to other areas which require such documentation in that many patient encounters are very similar. For instance, in a given month, an emergency doctor may see twenty people with chest pain, fifteen people with a twisted ankle, thirty with flu like symptoms, etc. With each, there are malady-specific questions that should be asked and answered. For example, on a chart for a patient presenting with “Chest Pain,” a physician should ask questions like “Is the pain pressure-like or not?” and “Did it start suddenly or gradually?” and “Do you have associated shortness of breath or not?” However, those questions are irrelevant for patients with a twisted ankle. Patients with a twisted ankle have other unique questions like whether the ankle was inverted or averted, etc.

Most EMR system have addressed this problem by creating hundreds of unique templates based on the chief complaint of the patient that guides the physician to document those questions/answers which the vendor of the EHR thinks are the most relevant and important. This results in hundreds of unique screens that are often very busy and have so much information that it is difficult to take it all in. Further, individual physicians often have unique documentation habits and preferences, and different geographies have different disease patterns that require unique documentation. For instance, in an area endemic to Lyme's disease, a physician documenting on a patient with Bell's Palsy will want to enquire about tick exposure more so than in an area without Lyme's prevalence. Existing EMR systems are not sufficiently adaptable to each physician's needs.

Therefore, an EMR system is needed which allows for customization by physicians, as well as a more efficient entry of information.

### SUMMARY OF THE INVENTION

This invention relates generally to a portable medical records method and system for creating and managing patient medical records, and for easily customizing the interface and functionality of the EMR system to fit the physician's particular needs. The embodiments disclosed herein may be implemented, without limitation, in physician offices and clinics, hospitals, ambulatory surgical centers, nursing homes, urgent care centers and other locations where a physician may see a patient for the purposes of diagnosing or treating the patient. The portable medical record system may present a user with specified options and notifications based on patient data and may be implemented via a portable computing device (e.g., a tablet computer, mobile phone, etc.). Patient data may be entered into the portable medical record system via graphical user interface of the portable computing device or video or audio recording aspects of the portable computing device. Patient data may be stored in non-transitory computer readable medium.

Based on patient data entered into the portable medical record system, the system may generate a template to facilitate the entry of additional patient data by a user. In one embodiment, the portable medical record system may display patient data or may display templates for patient data entry based on sections, including but not limited to the patient's chief complaint, history of present illness, PFS, review of systems, physical exam.

The user interface may be modified by a first user such that specified options or templates presented to the first user are different than options or templates presented to another user based. For example, a user may decide whether a button functions to record only a single value in the portable medical record system or functions to record multiple different values in the portable medical record system. When a button functions to record multiple different values in the portable medical record system, the value recorded may be determined by the area of the button touched by the user. Thus, as a non-limiting example, touching the left side of a button may result in a “yes” value while touching the right side of the button may result in a “no” value. “Touching” the left or right side of a button should be understood to include actions like swiping the button left or right, as would be understood in the art. Such modification of the user interface by a user may be performed by the user simultaneously with the entry of patient data. The user may elect to apply such modifications to a specific patient, to multiple patients or to all patients. The user may further record macros that automatically cause certain actions to take place.

The portable medical record system may also notify a user whether data entered by the user for a patient meets the billing requirements of a health plan. For example, a visual indicator on the portable medical record system may display different colors to signify compliance with health plan billing requirements. For example, the border of a button may become green to indicate that sufficient data has been provided about an aspect of patient care or diagnosis to comply with that patient's health plan billing requirements. The data requirements for a medical plan may be accessible such that the system merely accesses a database of medical plan requirements for a given procedure/pharmaceutical/etc., or the user may manually input such requirements.

The portable medical record system may use different colors to indicate to a user the purpose of a button, status of data entry, or button function. For example, each button that displays a category of patient data may be a first button color. When a user is accessing a category of patient data, a button corresponding to that category may change to a second button color. Further, each button that allows a user to perform certain functions, including, but not limited to, recording audio, video or handwriting data, may be a third color. A fourth button color may indicate to a user that the functionality of that button may be modified by the user. Further, the physical location of buttons may indicate to the user the purpose of function of the button.

Preferably, the portable medical record system may interface with other computer systems to transfer patient data entered by a user to the other computer systems (e.g. billing computer systems or electronic health record systems). The portable medical record system may implement safeguards to prevent unintended access of patient records, including, but not limited to, the encryption of patient data or the use of user biometric data or passwords to verify user authority to access data.

In one embodiment, a customization method comprises the following steps. A user is allowed to choose to create a new button via an input device, and a processor provides an option to the user to make the button either a single- or multiple-response button. An input is accepted from the user regarding a number of responses for the button via the input device, and the processor prompts the user to input a descriptor for each of the one or more responses chosen for the button. Each such descriptor is then accepted, and the button is displayed to the user on a display. Upon the button being pressed, the press of the button is accepted, and the processor determines which of the responses was selected by the press of the button. The corresponding descriptor is then stored in an electronic memory.

In another embodiment, a system for allowing customization of medical history data entry comprises a database including an electronic memory for storing records therein. The system also includes a processor for communicating with a remote device via a network. The processor receives inputs from a user regarding the creation of a new button and a number of responses associated with the button. The processor also receives a respective descriptor associated with each response, as well as a category for the button. The processor further instructs the remote device to display the button when the category is selected. The processor also receives a selection from the remote device upon a user pressing the button displayed on the remote device, and determines which selection was chosen by the user based upon the location at which the button was pressed. A button press on a right side of the button selects a first response, and a press of the button on a left side of the button selects a second response. The database records the selected response in an appropriate record.

Other and further objects of the invention, together with the features of novelty appurtenant thereto, will appear in the course of the following description.

### BRIEF DESCRIPTION OF THE DRAWINGS

In the accompanying drawings, which form a part of the specification and are to be read in conjunction therewith:

FIG. 1 illustrates a block diagram of an example computer system as is known in the art.

FIG. 2 illustrates a block diagram of the interconnection between remote devices and a system via the Internet.

FIG. 3 illustrates an example block diagram of a user interface as displayed on a remote device, according to an embodiment of the present invention.

FIG. 4 illustrates an example block diagram of a user interface after the “context” button has been selected, according to an embodiment of the present invention.

FIG. 5 illustrates a flow chart of a process for creating new buttons, according to an embodiment of the present invention.

FIG. 6 illustrates an example block diagram of a user interface for creating a new button, according to an embodiment of the present invention.

FIG. 7 illustrates an example block diagram of a dialog box for entering possible responses after a two-response button has been selected, according to an embodiment of the present invention.

FIG. 7 illustrates an example block diagram of a dialog box for entering possible responses after a two-response button has been selected, according to an embodiment of the present invention.

FIG. 8 illustrates an example block diagram of a user interface after a new button has been created, according to an embodiment of the present invention.

### DETAILED DESCRIPTION OF THE INVENTION

In the following detailed description of example embodiments, reference is made to the accompanying drawings that form a part hereof, and in which is shown by way of illustration specific example embodiments in which the inventive subject matter may be practiced. These embodiments are described in sufficient detail to enable those skilled in the art to practice the inventive subject matter, and it is to be understood that other embodiments may be utilized and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component that appears in multiple Figures. Signals and connections may be referred to by the same reference number or label, and the actual meaning will be clear from its use in the context of the description. Also, please note that the first digit(s) of the reference number for a given item or part of the example embodiments should correspond to the Figure number in which the item or part is first identified.

The description of the various embodiments is to be construed as exemplary only and does not describe every possible instance of the inventive subject matter. Numerous alternatives can be implemented, using combinations of current or future technologies, which would still fall within the scope of the claims. The following detailed description is, therefore, not to be taken in a limiting sense, and the scope of the inventive subject matter is defined only by the appended claims.

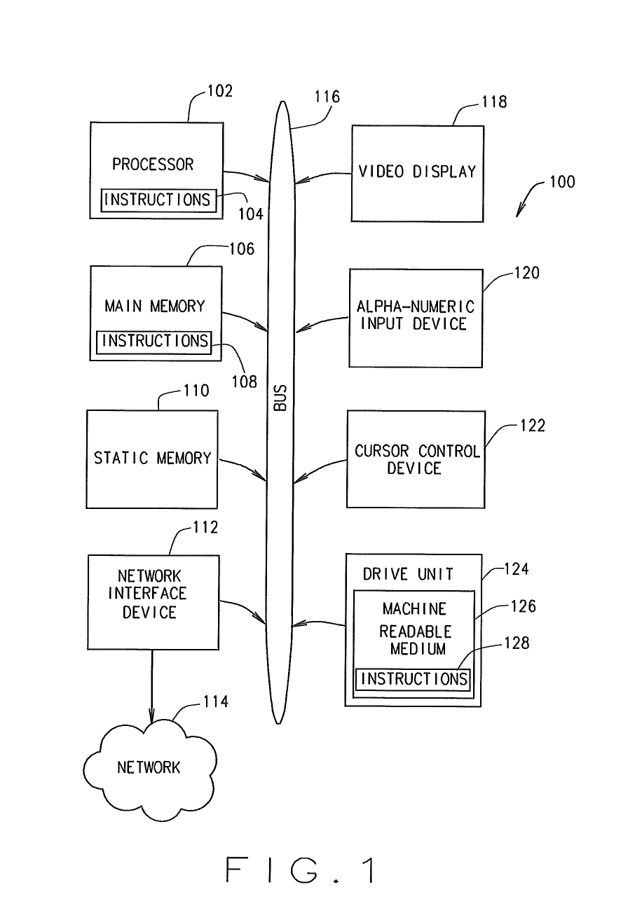

FIG. 1 is a block diagram of an example embodiment of a computer system 100 upon which an embodiment's inventive subject matter may execute. The description of FIG. 1 is intended to provide a brief, general description of suitable computer hardware and a suitable computing environment in conjunction with which the embodiments may be implemented. In some embodiments, the embodiments are described in the general context of computer-executable instructions, such as program modules, being executed by a computer. Generally, program modules include routines, programs, objects, components, data structures, etc., that perform particular tasks or implement particular abstract data types.

The system as disclosed herein can be spread across many physical hosts. Therefore, many systems and sub-systems of FIG. 1 can be involved in implementing the inventive subject matter disclosed herein.

Moreover, those skilled in the art will appreciate that the embodiments may be practiced with other computer system configurations, including hand-held devices, multiprocessor systems, microprocessor-based or programmable consumer electronics, network PCs, minicomputers, mainframe computers, and the like. The embodiments may also be practiced in distributed computer environments where tasks are performed by I/O remote processing devices that are linked through a communications network. In a distributed computing environment, program modules may be located in both local and remote memory storage devices.

In the embodiment shown in FIG. 1, a hardware and operating environment is provided that is applicable to both servers and/or remote clients.

With reference to FIG. 1, an example embodiment extends to a machine in the example form of a computer system 100 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The example computer system 100 may include a processor 102 (e.g., a central processing unit (CPU), a graphics processing unit (GPU), or both), a main electronic memory 106 and a static electronic memory 110, which communicate with each other via a bus 116. The computer system 100 may further include a video display unit 118 (e.g., a liquid crystal display (LCD) or a cathode ray tube (CRT)). In example embodiments, the computer system 100 also includes one or more of an alpha-numeric input devices 120 (e.g., a keyboard or touch pad or touch screen), a user interface (UI) navigation device or cursor control device 122 (e.g., a mouse, a touch screen), a disk drive unit 124, a signal generation device (e.g., a speaker), and a network interface device 112. The aforementioned components also communicate with each other via the bus 116.

The disk drive unit 124 (which may also be a solid state drive) includes a machine-readable medium 126 on which one or more sets of instructions 128 and data structures (e.g., software instructions) embodying or used by any one or more of the methodologies or functions described herein are stored. The instructions 128 may also reside, completely or at least partially, within the main memory 108 or within the processor 104 during execution thereof by the computer system 100, the main memory 106 and the processor 102 also constituting machine-readable media.

While the machine-readable medium 126 is shown in an example embodiment to be a single medium, the term “machine-readable medium” may include a single medium or multiple media (e.g., a centralized or distributed database, or associated caches and servers) that store the one or more instructions. The term “machine-readable storage medium” shall also be taken to include any tangible medium that is capable of storing, encoding, or carrying instructions for execution by the machine and that cause the machine to perform any one or more of the methodologies of embodiments, or that is capable of storing, encoding, or carrying data structures used by or associated with such instructions. The term “machine-readable storage medium” shall accordingly be taken to include, but not be limited to, solid-state memories and optical and magnetic media that can store information in a non-transitory manner, i.e., media that are able to store information for a period of time, however brief. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

The instructions 128 may further be transmitted or received over a communications network 114 using a transmission medium via the network interface device 112 and utilizing any one of a number of well-known transfer protocols (e.g., FTP, HTTP). Examples of communication networks include a local area network (LAN), a wide area network (WAN), the Internet, mobile telephone networks, plain old telephone service (POTS) networks, wireless data networks (e.g., Wi-Fi, WiMAX, and LTE networks), as well as any proprietary electronic communications systems that might be used. The term “transmission medium” shall be taken to include any intangible medium that is capable of storing, encoding, or carrying instructions for execution by the machine, and includes digital or analog communications signals, or other intangible medium to facilitate communication of such software.

The example computer system 100, in the preferred embodiment, includes operation of the entire system on a remote server with interactions occurring from individual connections over the network 114 to handle user input as an internet application.

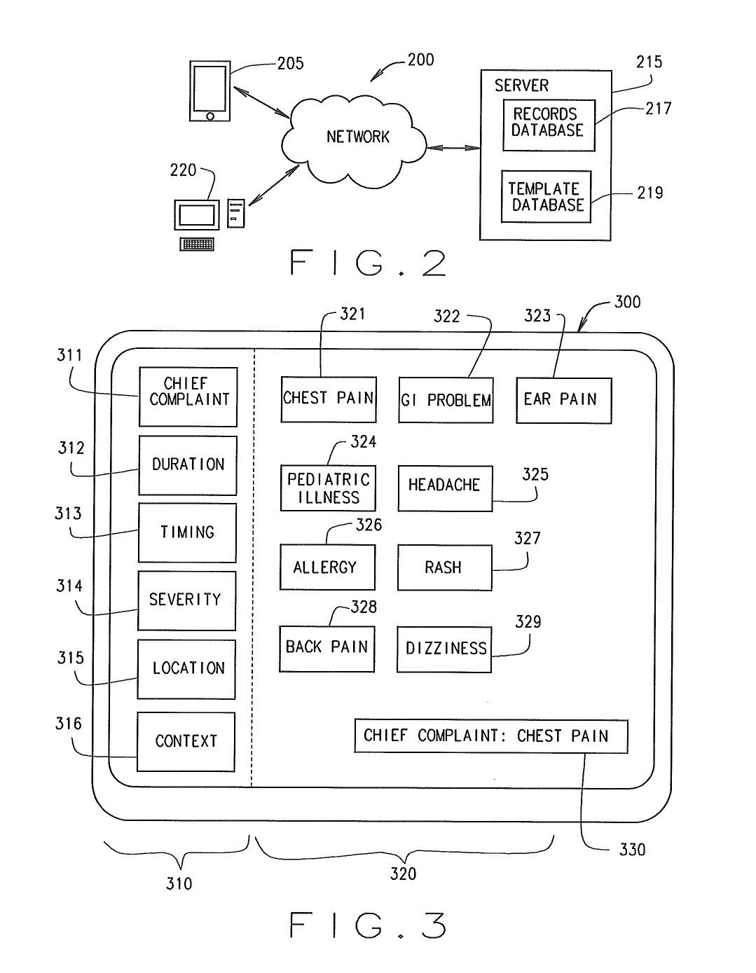

FIG. 2 illustrates a block diagram of an exemplary system 200. In system 200, a remote device 205, which may be a tablet with an input device (generally a touch screen), a display, etc., is connected via a network 210 with one or more servers 215. Server 215 may contain electronic memory which stores a medical records database 217, as well as a template database 219. As would be understood, medical records database 217 and template database 219 could be a single database, or multiple databases stored across multiple servers 215. Additional remote devices such as computer 210 may also be connected via network 210. In operation, remote device 205 communicates with server 215 regarding patient medical records, as well as customizations of templates used by one or more remote devices 205. In theory, remote device 205 could contain the databases 217, 219.

FIG. 3 illustrates a basic block diagram of a user interface 300 displayed by the remote device 205. This user interface 300 should not be considered limiting, and is merely used as an example. Sections area 310 includes buttons for various sections. For example, as shown, section area 310 includes a “chief complaint” button 311, a “duration” button 312, a “timing” button 313, a “severity” button 314, a “location” button 315, and a “context” button 316. Each of these sections relates to types of information which a physician may want to input regarding a patient. For example, in FIG. 3, the chief complaint button 311 has been pressed and the subsection area 320 displays various subsection buttons relating to the chief complaint section. As shown, non-limiting examples of these subsection buttons include a “chest pain” button 321, a “GI problem” button 322, an “ear pain” button 323, a “pediatric illness” button 324, a “headache” button 325, an “allergy” button 326, a “rash” button 327, a “back pain” button 328, and a “dizziness” button 329. By selecting, for example, the chest pain button 321, a status box 330 reads “Chief Complaint: Chest Pain” to reflect that the chest pain subsection of the chief complaint section has been selected.

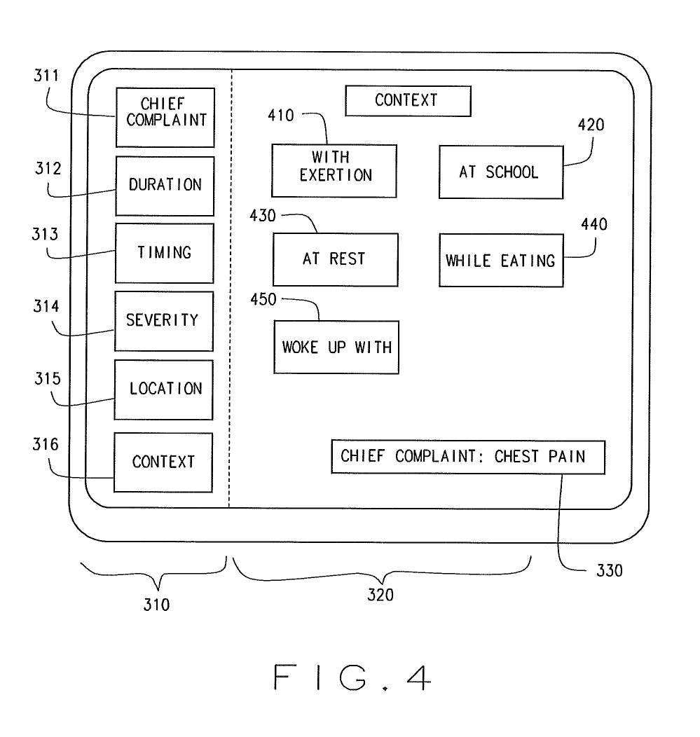

The above chief complaint of chest pain can be further supplemented by selecting an additional section in the section area 310. For example, in FIG. 4, the context button 316 has been selected. As can be seen, different buttons appear in the subsection area 320 after the context button 316 button has been selected as compared to when the chief complaint button 311 was selected. The status box may still be present and may retain the same “Chief Complaint: Chest Pain” information to clarify that the chest pain chief complaint is still being modified. Non-limiting examples of these new subsection buttons shown in FIG. 4 include a “with exertion” button 410, an “at school” button 420, an “at rest” button 430, a “while eating” button 440, and a “woke up with” button 450. Pressing any of these subsection buttons 410-450 would add such a descriptor to the patient's medical record.

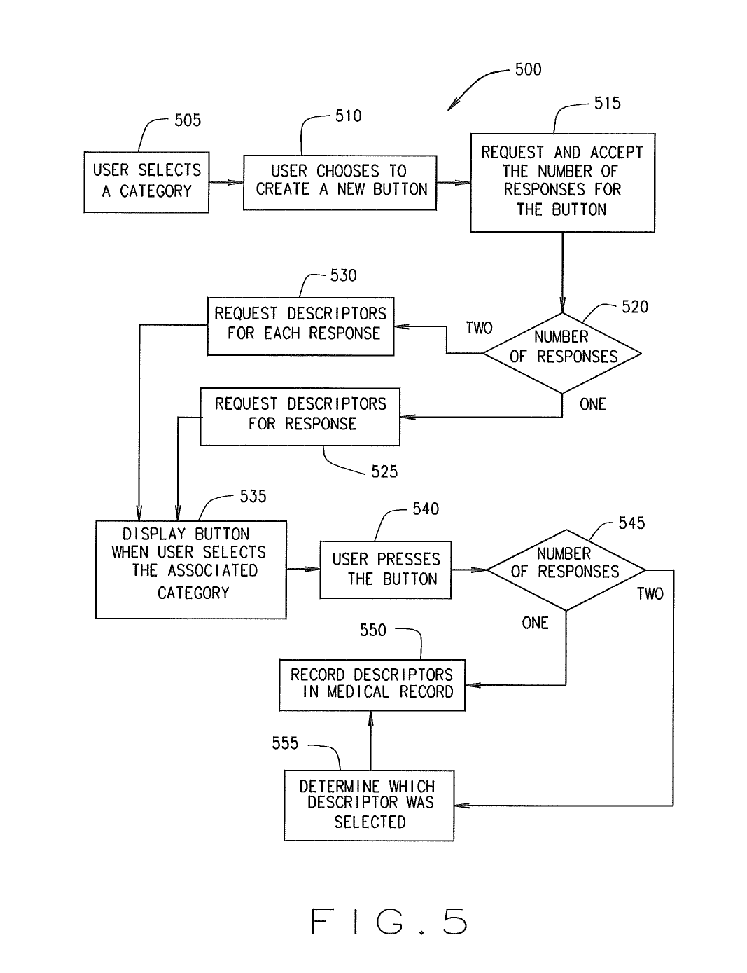

However, as discussed above, the existing section and subsection options may not be sufficient for all physicians in all areas at all times. Therefore, FIG. 5 illustrates a process 500 for creating and using a new button. At step 505, a user selects a category. A category may be a section, or a subsection, or the like. For example, in FIG. 4 with a chief complaint of “chest pain” already having been selected, a user may decide to create a new button within the context section. Thus, the context section would be the category which is selected in this example at step 505. However, the user could choose a subsection as the category, such as by choosing the “while eating” subsection button 440 to add a new button within the “while eating” subsection. This process will be discussed below. Thus, the definition of category is any section, subsection, etc. into which the user wants to add a new button. For the purposes of this example, the selected category into which a new button will be created is the context section.

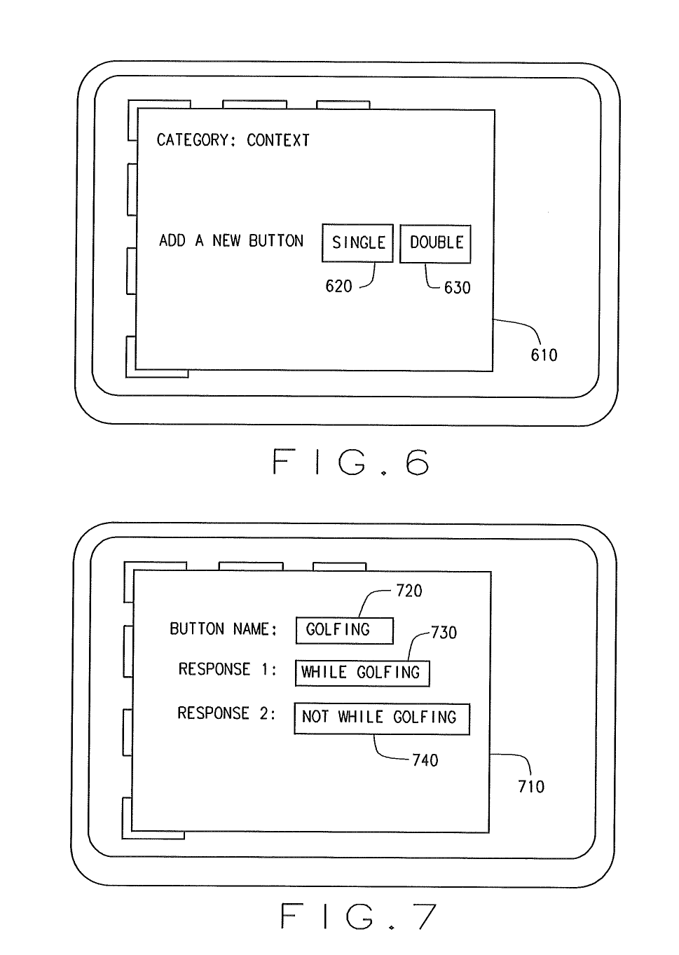

At step 510, the user chooses to create a new button and may input the name of the button. To create a new button, the user may simply press and hold the desired category button, or may press the desired category button followed by another “create button” button, as would be understood in the art (but not shown). At step 515, the system requests and accepts a number of available responses for the button from the user. For example, as is illustrated in FIG. 6, a dialog box 610 offering “single” and “double” buttons 620, 630 is displayed. Selecting the single button 620 creates a button with only a single response, while selecting the double button 630 creates a button with two possible responses. At step 520, the number of chosen responses is determined upon selection by the user. At step 525, if the user chooses only a single response, a descriptor for the single response is requested. At step 530, if the user chooses two responses, a descriptor for each response is requested. For example, FIG. 7 illustrates a dialog box 710 for entering possible responses after a two-response button has been selected. Field 720 allows the user to confirm or modify the name of the new button, while fields 730 and 740 allow the user to input the first and second descriptors/responses. As shown, the button name is “Golfing” while the first and second responses are “While Golfing” and “Not While Golfing.”

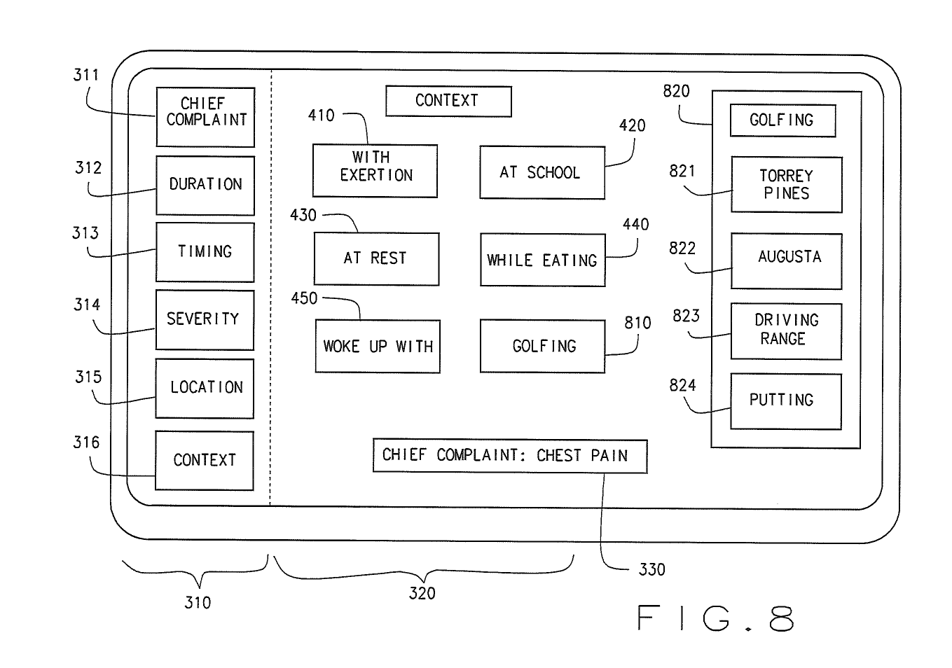

Whether a single response button or a double response button has been chosen, the process advances to step 535, in which the new button is displayed. For example, as shown in FIG. 8, the new golfing button 810 is shown as a subsection under the context section when chest pain has been selected as the chief complaint.

At step 540, a user presses the newly created button. At step 545, a check is made to determine the number of possible responses for the button. Where the button is only a single-response button, the descriptor for that button is added to the patient's medical record at step 550. However, when the button is a dual-response button, at step 555, a determination is made as to which descriptor was selected by the user. For example, pressing the left side of the button may select the first descriptor, whereas pressing the right side of the button may select the second descriptor. Of course, other ways of selecting various descriptors via a single button are envisioned, such as swiping the button left or right, or pressing and holding the button until the possible options are displayed, or simply popping up a new window with the available options upon the user's press of the new button 810, etc. The process 500 then advances to step 550 at which the selected descriptor is recorded in the medical record.

It is noted that a double-response button could simply offer positive and negative choices. For example, with a button named “golfing,” the first option could be a positive “golfing” while the second option could be the negative “not golfing.” In such an embodiment, steps 525 and 530 at which the descriptors for the various options are requested may be skipped.

Further, buttons with more than two responses are envisioned. In such an embodiment, three or more descriptors could be input. The system could determine which option is selected by the location at which the button is pressed or swiped as discussed above. Alternatively, selecting the button could cause a new dialogue box to open with the various options available, such that the user can select the appropriate response from a list. Effectively, the button could be turned into a category itself, with various options beneath it. This is also shown in FIG. 8. As can be seen, pressing the golfing button 810 may open a golfing box 820 which contains various buttons therein: a Torrey Pines button 821, an Augusta button 822, a driving range button 823, and a putting button 824. By selecting any of these buttons in the golfing box 820, that information would be added to the patient's medical records. Selecting, for example, the Torrey Pines button 821 in the situation described herein would cause the patient's medical record to recite: “Chief Complaint: Chest Pain; Context: Golfing (Torrey Pines).”

When and where the new button appears can be defined by the user. For example, the user could cause the new button only to appear in the selected category/section/subsection, or in all categories/sections/subsections, as appropriate. A slider may be present in dialog box 610 of FIG. 6 which would allow the user to choose whether the new button is available, for example for all chief complaints, or only for the chosen chief complaint. Alternatively, the user could choose to have the button appear only during the summer, or only at night, or only when the remote terminal is located within a certain geographic area. New buttons and other changes to the physician's template may be stored in template database 219.

A new button may also be created which is set to notify the user as to whether data entered by the user meets the billing requirements of a health plan. For example, a visual indicator may display different colors to signify compliance with health plan billing requirements. The border of a button may become green to indicate that sufficient data has been provided about an aspect of patient care or diagnosis to comply with that patient's health plan billing requirements or other requirements. The data requirements for a medical plan may be accessible such that the system merely accesses a database of medical plan requirements for a given procedure/pharmaceutical/etc., or the user may manually input such requirements.

The various system examples shown above illustrate a novel system and method. A user of the present invention may choose any of the above embodiments, or an equivalent thereof, depending upon the desired application. In this regard, it is recognized that various forms of the subject invention could be utilized without departing from the spirit and scope of the present invention.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

What is claimed is:

1. A customization method comprising the steps of:
(a) allowing a user to choose to create a new button via an input device;
(b) providing, via a processor; an option to the user to make said button one of a single and multiple response button;
(c) accepting an input from the user regarding a number of responses for said button via said input device;
(d) prompting, via the processor, the user to input a descriptor for each of the number of responses chosen for said button;
(e) accepting each said descriptor from the user via the input device;
(f) displaying, via the processor, said button to the user on a display;
(g) accepting a press of the button via the input device;
(h) determining, via a processor, which of the number of responses was selected by the press of the button; and
(i) recording, in an electronic memory, the descriptor associated with the response selected by the press of the button.

2. The method of claim 1 wherein the number of responses for said button is at least two.

3. The method of claim 2 wherein a press of the button on a right side of the button selects a first of said at least two responses, and a press of the button on a left side of the button selects a second of said at least two responses.

4. The method of claim 2 wherein a second of said responses is a negative of a first of said responses.

5. The method of claim 4 wherein a selection of the first response causes said button to turn a first color, and a selection of the second response causes said button to turn a second color.

6. The method of claim 1 wherein said user selects a category for said button, and said button is displayed only in the context of the selected category.

7. The method of claim 6 wherein a said category is a category of medical symptoms.

8. The method of claim 1 further including the steps of:
accepting instructions from a user via the input device to create a second level button;
accepting a descriptor for said second level button from said user via the input device;
displaying said second level button on said display only when said button has been selected;
recording, in said electronic memory, said descriptor for said second level button in connection with the descriptor for the button when said button and said second level button are selected by the user.

9. The method of claim 8 wherein said second level button is not displayed when at least one of said number of responses is selected.

10. A system for allowing customization of medical history data entry comprising:
a database including an electronic memory for storing records therein;
a processor for communicating with a remote device via a network, said processor for receiving inputs from a user regarding the creation of a new button and a number of responses associated with said button, with a respective descriptor associated with each response, and a category for the button;
said processor instructing the remote device to display the button when the category is selected;
said processor also for receiving a selection from the remote device upon a user pressing the button displayed on the remote device;
said processor determining which selection was chosen by the user based upon the location at which the button was pressed, wherein a button press on a right side of the button selects a first response, and a press of the button on a left side of the button selects a second response;
said database recording the selected response in an appropriate record.

11. The system of claim 10 wherein said processor is a component of the remote device.
